(19) United States
(12) Patent Application Publication
(10) Pub. No.: US 2018/0276590 A1
(43) Pub. Date: Sep. 27, 2018

(54) NON-TRANSITORY COMPUTER-READABLE STORAGE MEDIUM, PROCESS PLANNING METHOD, AND PROCESS PLANNING DEVICE

(71) Applicant: FUJITSU LIMITED, Kawasaki-shi (JP)

(72) Inventors: MITSURU KUBO, Kawasaki (JP); Satoshi TOMITA, Kawasaki (JP); Yukio Ozaki, Yokohama (JP)

(73) Assignee: FUJITSU LIMITED, Kawasaki-shi (JP)

(21) Appl. No.: 15/888,135

(22) Filed: Feb. 5, 2018

(30) Foreign Application Priority Data
Mar. 23, 2017 (JP) 2017-058143

(51) Int. Cl. G06Q 10/06

(52) U.S. Cl. CPC G06Q 10/06316; B25J 9/0093

(57) ABSTRACT

Provided is a storage medium storing a program causing a computer to execute a process, the process including: repeating creation of a process plan and calculation of parameter values of the created process plan until calculated parameter values fall within respective first target ranges; storing the calculated parameter values; outputting the created process plan where all the calculated parameter values are within the respective first target ranges; when receiving a specification of a parameter value and a change of a target range of a specified parameter value to a second target range, determining a third target range of an unspecified parameter value based on the second target range and stored parameter values; repeating the creation and the calculation until the specified and unspecified parameter values respectively fall within the second and third target ranges; and outputting the created process plan where all the parameter values are within respective target ranges.

### CROSS-REFERENCE TO RELATED APPLICATION

This application is based upon and claims the benefit of priority of the prior Japanese Patent Application No. 2017-058143 filed on Mar. 23, 2017, the entire contents of which are incorporated herein by reference.

### FIELD

A certain aspect of the embodiments described herein relates to a non-transitory computer-readable storage medium, a process planning method, and a process planning device.

### BACKGROUND

In job planning (also called process planning) for assigning jobs to processes (working subjects) of an assembly line for assembling products, optimization has been conducted taking into consideration the compliance with the order of jobs at the processes and the balance of workloads among the processes. It is difficult to manually conduct the optimization, and searching all patterns of job assignment is time consuming and is not practical. Thus, there have been suggested various algorithms (e.g., local search).

### SUMMARY

According to an aspect of the embodiments, there is provided a non-transitory computer readable storage medium storing a process planning program that causes a computer to execute a process, the process including: repeating a process of creating a candidate process plan, by assigning a plurality of jobs to a plurality of processes, and calculating a plurality of parameter values of the candidate process plan until a plurality of calculated parameter values fall within respective first target ranges of the plurality of parameter values; storing the plurality of calculated parameter values in a storage unit; outputting the candidate process plan in which all of the plurality of calculated parameter values are within the respective first target ranges; when receiving input of information about a parameter value specified from among the plurality of parameter values by a user and information about a change of a target range of a specified parameter value to a second target range, determining a third target range of a parameter value not specified by the user based on the second target range and a plurality of parameter values stored in the storage unit; repeating the process of creating a candidate process plan and calculating the plurality of parameter values of the candidate process plan until the parameter value specified by the user of the plurality of calculated parameter values falls within the second target range and the parameter value not specified by the user falls within the third target range; and outputting a candidate process plan in which all of the plurality of parameter values are within respective target ranges.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates a hardware configuration of a process planning device in accordance with an embodiment;

FIG. 2 illustrates an assembly line for which a process plan is created;

FIG. 3 illustrates a process plan (a candidate process plan) when jobs are assigned to the assembly line of FIG. 2;

FIG. 4 is a diagram for describing parameters;

FIG. 5 is a functional block diagram of the process planning device;

FIG. 6 illustrates a data structure of a job DB;

FIG. 7A illustrates a data structure of a parameter value storage unit, and FIG. 7B illustrates a data structure of a correlation model storage unit;

FIG. 8A through FIG. 8C are diagrams for describing a process by a correlation model creation unit;

FIG. 9 is a flowchart of a process by the process planning device;

FIG. 10A through FIG. 10C are diagrams (No. 1) for describing the process by the process planning device;

FIG. 11A through FIG. 11C are diagrams (No. 2) for describing the process by the process planning device;

FIG. 12A and FIG. 12B are diagrams (No. 3) for describing the process by the process planning device; and

FIG. 13A through FIG. 13C are diagrams (No. 4) for describing the process by the process planning device.

### DESCRIPTION OF EMBODIMENTS

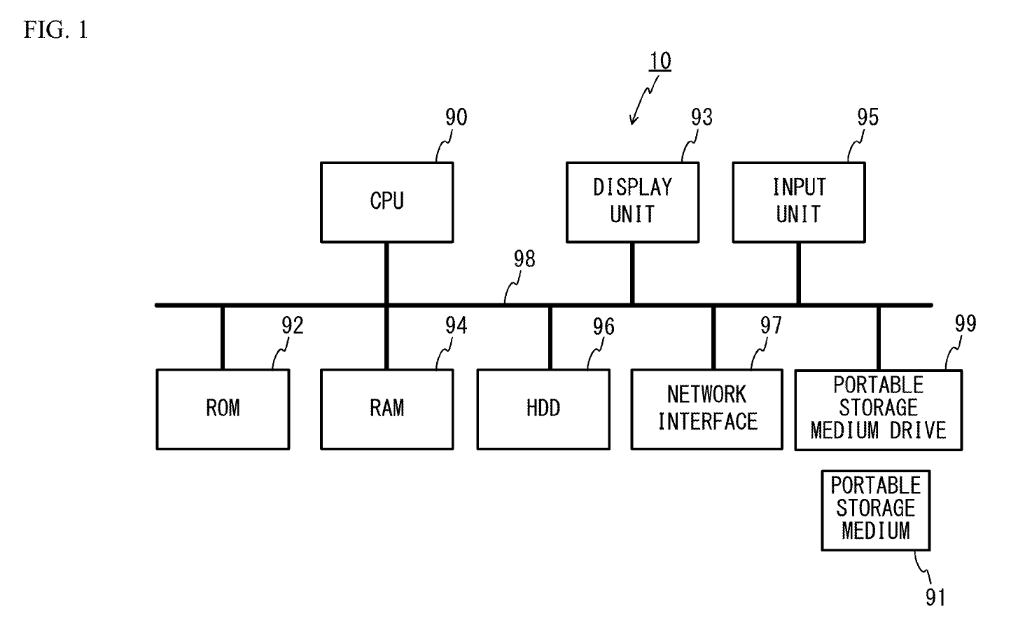

Hereinafter, a detailed description will be given of an embodiment of a process planning device with reference to FIG. 1 through FIG. 13C.

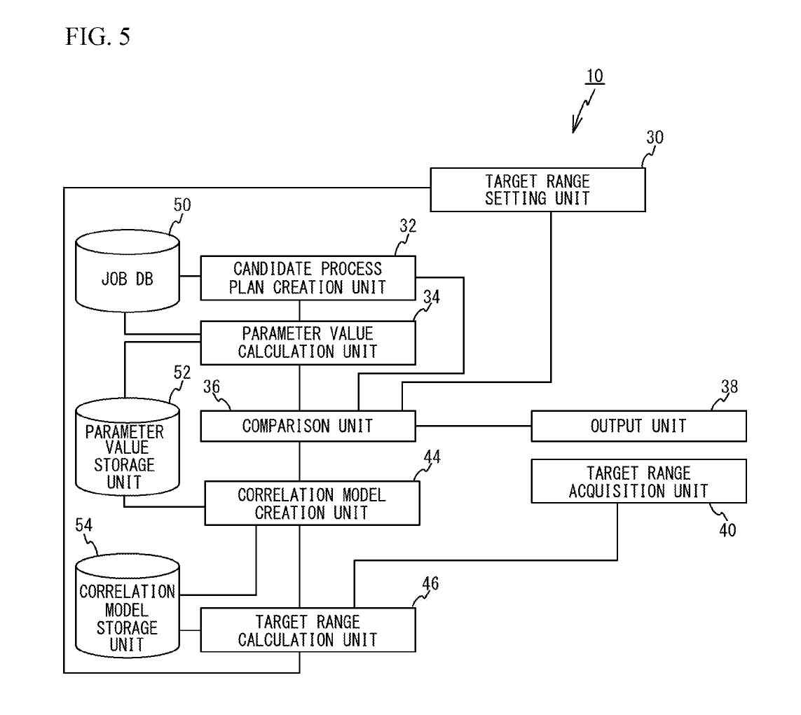

FIG. 1 illustrates a hardware configuration of a process planning device 10 in accordance with an embodiment. The process planning device 10 of the present embodiment is an information processing device such as a personal computer (PC), and as illustrated in FIG. 1, includes a central processing unit (CPU) 90, a read only memory (ROM) 92, a random access memory (RAM) 94, a storage unit (here, a hard disk drive (HDD)) 96, a network interface 97, a portable storage medium drive 99, a display unit 93, an input unit 95, and the like. Examples of the display unit 93 include, but are not limited to, a liquid crystal display, and examples of the input unit 95 include, but are not limited to, a keyboard, a mouse, and a touch panel. Each of these components of the process planning device 10 is coupled to a bus 98. In the process planning device 10, the function of each unit illustrated in FIG. 5 is implemented by executing programs (including a process planning program) stored in the ROM 92 or the HDD 96 by the CPU 90 or by executing programs (including the process planning program) read from a storage medium 91 by the portable storage medium drive 99 by the CPU 90. FIG. 5 also illustrates a job database (DB) 50 stored in the HDD 96 or the like of the process planning device 10, a parameter value storage unit 52, and a correlation model storage unit 54. Examples of the portable storage medium 91 include, but are not limited to, a CD-ROM, a DVD disk, a portable storage medium such as a universal serial bus (USB) memory, and a semiconductor memory such as a flash memory.

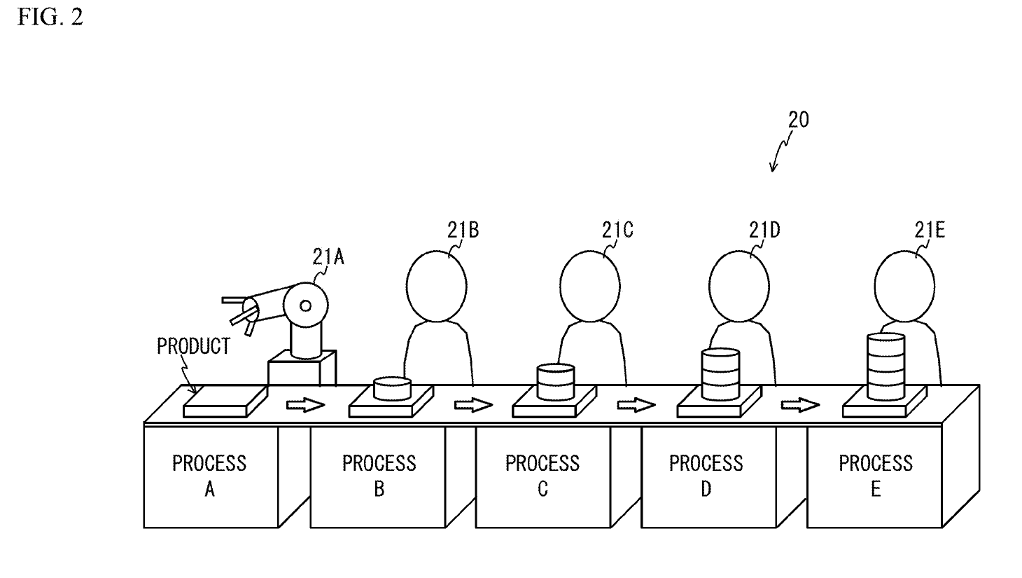

Here, the process planning device 10 of the present embodiment creates a process plan for an assembly line such as illustrated in FIG. 2. It is assumed that an assembly line 20 for assembling products has five processes: processes A through processes E, as illustrated in FIG. 2.

In the assembly line 20, a product is conveyed from the process to the process by a belt conveyor (not illustrated). A robot 21A and persons (workers) 21B through 21E are assigned to the processes of the assembly line 20. In the example of FIG. 2, the robot 21A is assigned to the process A, and the workers 21B through 21E are respectively assigned to the process B through the process E. The robot 21A and the workers 21B through 21E respectively assigned to the process A through the process E produce products by executing jobs assigned by process planning to the products conveyed in the assembly line 20.

The configuration example of the assembly line 20 is not limited to the configuration illustrated in FIG. 2. For example, the assembly line 20 may include six or more processes, or may include less than five processes. In addition, the robot 21A may be assigned to other than the process A, and the number of robots may be two or more.

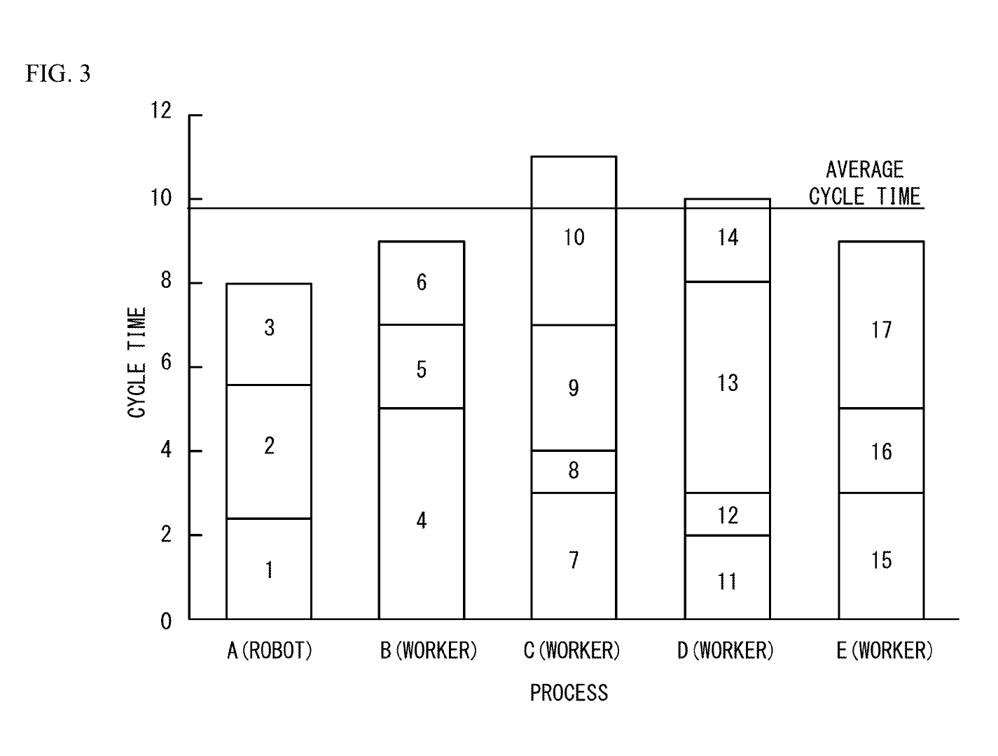

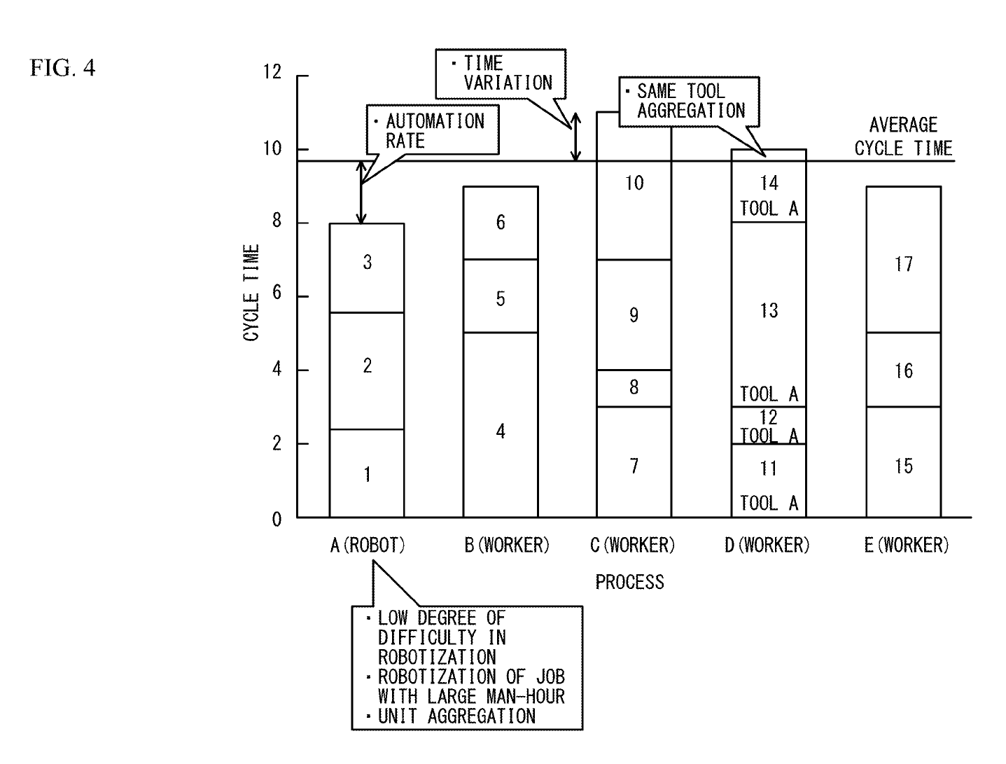

FIG. 3 illustrates a process plan (a candidate process plan) in which jobs 1 through 17 are assigned to the above five processes. When jobs are assigned to the processes including a process to which a robot is assigned such as illustrated in FIG. 2, multiple parameters such as parameters relating to workability of workers and robots need to be taken into consideration. The parameters include, as illustrated in FIG. 4, parameters such as an automation rate, a time variation, same tool aggregation, a low degree of difficulty in robotization, robotization of job with large man-hour, and unit aggregation. The process planning device 10 of the present embodiment creates a candidate process plan as illustrated in FIG. 3, and calculates a value of each parameter of the created candidate process plan. Then, when there is a candidate process plan in which all the parameter values fall within the respective target ranges, the process planning device 10 outputs the candidate process plan to a user (a process plan formulator). The process plan formulator checks the candidate process plan that has been output, and determines whether to adopt the candidate process plan as a process plan.

Here, the “automation rate” is a parameter that is to be taken into consideration to improve a labor saving effect and indicates the proximity between the cycle time of the robot and the average cycle time of processes executed by workers. The cycle time means a time required for one work cycle. The “time variation” is a parameter that is to be taken into consideration so as to prevent a worker from waiting as much as possible and indicates the variation in cycle time among processes. The “same tool aggregation” is a parameter that is to be take into consideration to reduce the cost for jigs and tools and indicates the degree of aggregation of jobs using the same jig or the same tool into the same process. The “low degree of difficulty in robotization” is a parameter that is to be taken into consideration to reduce a cost for developing a robot or percent defective and indicates the degree of aggregation of jobs of which the technical difficulty in robotization is low into the process executed by a robot. The “robotization of job with large man-hour” is a parameter that is to be taken into consideration to improve the cost effect by robotization and indicates the degree of aggregation of jobs of which the man-hour is large when a worker executes the job into the process executed by a robot. The “unit aggregation” is a parameter that is to be taken into consideration to reduce handling and indicates the degree of aggregation of jobs for mounting a part to the same part into the same process.

The process planning device 10 may not necessarily take into consideration all the above parameters, or may take into consideration other parameters.

FIG. 5 is a functional block diagram of the process planning device 10. In the process planning device 10, the execution of programs by the CPU 90 implements, as illustrated in FIG. 5, functions as a target range setting unit 30, a candidate process plan creation unit 32, a parameter value calculation unit 34, a comparison unit 36, an output unit 38 as first and second output units, a target range acquisition unit 40 as an input reception unit, a correlation model creation unit 44, and a target range calculation unit 46.

The target range setting unit 30 obtains parameters (types) to be taken into consideration when creating a process plan and respective target ranges (first target ranges) of the parameters to be taken into consideration input by a process plan formulator, and set them. Additionally, when the process plan formulator changes the target range of a certain parameter to another target range (a second target range), the target range setting unit 30 sets the target range after the change as a new target range. Furthermore, for the target range for the parameter not changed by the process plan formulator, the target range setting unit 30 sets a target range calculated by the target range calculation unit 46 (a third target range) as a new target range.

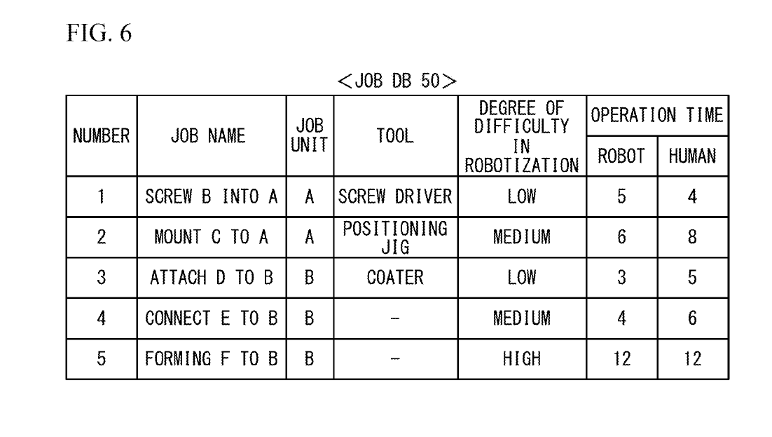

The candidate process plan creation unit 32 creates a candidate process plan by referring to the job DB 50 and assigning jobs to each process with use of local search. As the local search, for example, a hill climbing method, a tabu search, simulated annealing, and the like can be used. Here, the job DB 50 has a data structure such as illustrated in FIG. 6. As illustrated in FIG. 6, the job DB 50 includes “number”, “job name”, “job unit”, “tool”, “degree of difficulty in robotization”, “operation time (robot)”, and “operation time (human)” fields. The “number” field stores an identification number allocated to each job, and the “job name” field stores the name of the job. The “job unit” field stores the name of a part to which another part is to be mounted, and the “tool” field stores the name of a jig or tool used in the job. The “degree of difficulty in robotization” field stores the degree of technical difficulty for robotizing the job. The “operation time (robot)” field stores a prospective time when a robot executes the job, and the “operation time (human)” field stores a prospective time when a worker executes the job. When order constraint conditions are set, the candidate process plan creation unit 32 creates a candidate process plan according to the order constraint conditions.

The parameter value calculation unit 34 refers to the job DB 50 and calculates the value of each parameter of the candidate process plan created by the candidate process plan creation unit 32.

Here, when the parameters is the “time variation”, a value (CTmax/CTave) is calculated by dividing the cycle time CTmax of the process having the cycle time of which the difference from the average cycle time is the largest by the average CTave of cycle times of processes executed by workers. For the parameter “time variation”, a less value of means a better value. When the parameter is the “unit aggregation”, a value corresponding to the number of units included in the process executed by a robot is set (a larger value is set for the less number of units). For example, when the number of units is one, the parameter value is set as 10, and when the number of units is two, the parameter value is set as 9 so that a larger parameter value means a better value. When the parameter is the “automation rate”, a value (MCT/CTave) is calculated by dividing the cycle time (the average if a plurality of processes are present) MCT of the process executed by a robot by the average CTave of cycle times of processes executed by workers. For the parameter “automation rate”, a larger value means a better value.

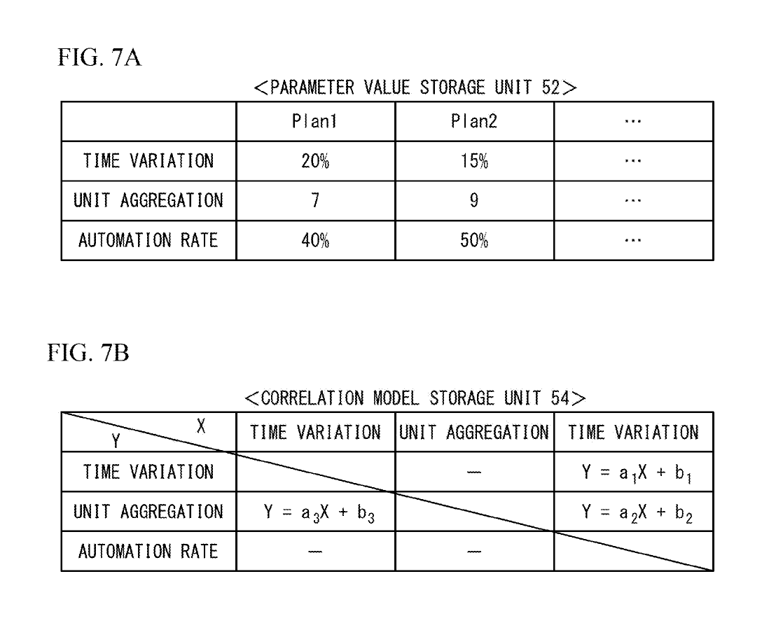

The parameter value calculation unit 34 stores all the calculated parameter values in the parameter value storage unit 52. The parameter value storage unit 52 has a data structure such as illustrated in FIG. 7A. As illustrated in FIG. 7A, the parameter value storage unit 52 stores parameter values calculated at the same timing in association with each other every time parameter values are calculated.

The comparison unit 36 compares each parameter value of the candidate process plan calculated by the parameter value calculation unit 34 with the corresponding target range set by the target range setting unit 30 to determine whether all the parameters are within the respective target ranges. When determining that all the parameters are within the respective target ranges, the comparison unit 36 notifies the output unit 38 of that, while when there is even one parameter not included in the corresponding target range, the comparison unit 36 notifies the candidate process plan creation unit 32 of that. When receiving the notification, the candidate process plan creation unit 32 creates a new candidate process plan.

The output unit 38 displays (outputs) the candidate process plan created by the candidate process plan creation unit 32 on the display unit 93 when receiving the notification from the comparison unit 36. In this case, the process plan formulator can check the candidate process plan displayed on the display unit 93.

When obtaining information indicating that the process plan formulator who checked the candidate process plan has specified a parameter value and information indicating that the process plan formulator has changed the target range of the specified parameter, the target range acquisition unit 40 notifies the target range calculation unit 46 of that. Here, when checking a candidate process plan such as illustrated in FIG. 3, the process plan formulator considers whether to adopt the displayed candidate process plan or whether to change the target range of any one of the parameter values to recreate a candidate process plan. When changing the target range of any one of the parameter values, the process plan formulator inputs the decision through the input unit 95.

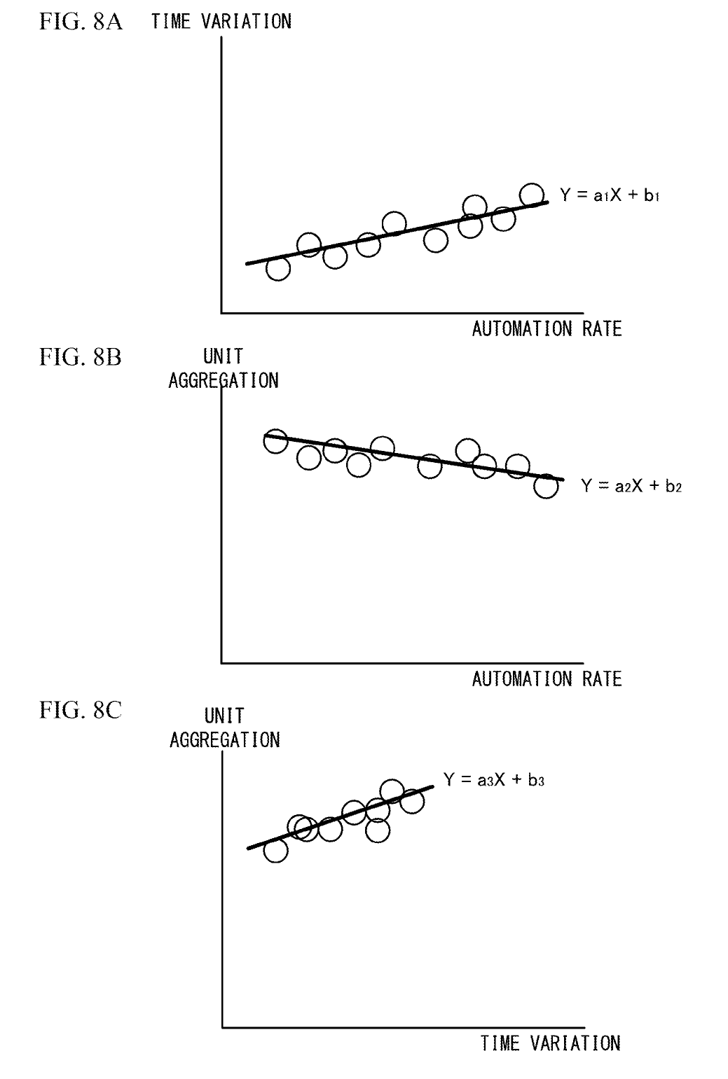

The correlation model creation unit 44 refers to the parameter value storage unit 52 to create a model indicating correlations between the parameters. For example, it is assumed that parameter values such as illustrated in FIG. 8A through FIG. 8C are obtained when the “time variation”, the “unit aggregation”, and the “automation rate” are set as parameters to be used. In this case, the correlation model creation unit 44 creates correlation models between the parameters by using the least-square method or the like. In FIG. 8A through FIG. 8C, the correlation model is represented by a linear expression. The correlation model creation unit 44 stores the created correlation models (linear expressions) in the correlation model storage unit 54 (FIG. 7B). More specifically, as illustrated in FIG. 7B, the correlation model storage unit 54 stores a linear expression representing the correlation model between parameters for each pair of two parameters.

Returning to FIG. 5, when receiving from the target range acquisition unit 40 the notification of information indicating that the target range of a certain parameter was changed, the target range calculation unit 46 calculates the target ranges for the parameters not changed by the process plan formulator. In this case, the target range calculation unit 46 calculates the unchanged target ranges for the parameters based on the correlation models stored in the correlation model storage unit 54 and the changed target range. The target range calculation unit 46 transmits the target range of the certain parameter value changed by the process plan formulator and the target range of the parameter value that was not changed by the process plan formulator and was calculated by the target range calculation unit 46 to the target range setting unit 30.

### Process by the Process Planning Device 10

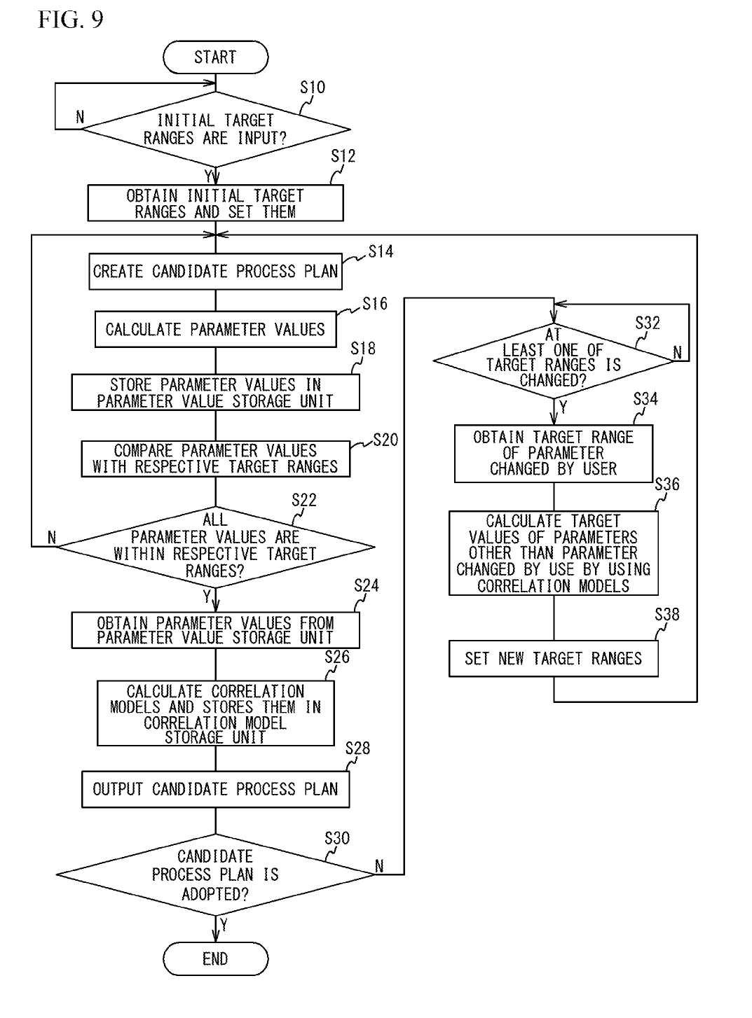

Next, a detailed description will be given of a process by the process planning device 10 along a flowchart illustrated in FIG. 9 by referring to other drawings appropriately. It is assumed that information on jobs that need to be assigned to each process is stored in the job DB 50 before the execution of the process in FIG. 9.

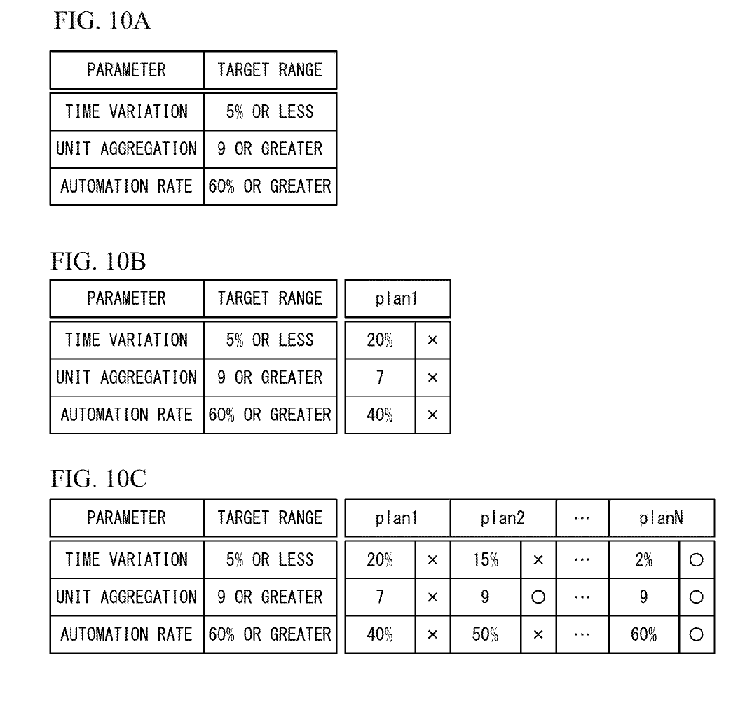

In the process in FIG. 9, first, at step S10, the target range setting unit 30 waits until initial target ranges are input. When a process plan formulator inputs parameters (types) to be used for creating a process plan and target ranges of parameter values through the input unit 95, the target range setting unit 30 moves to step S12. In the present embodiment, as illustrated in FIG. 10A, it is assumed that the “time variation”, the “unit aggregation”, and the “automation rate” are input as parameters to be used. Additionally, it is assumed that “5% or less” is input as the target range for the “time variation”, “9 or greater” is input as the target range for the “unit aggregation”, and “60% or greater” is input as the target range for the “automation rate”. The process plan formulator intentionally sets bad values as initial target ranges. The above combination of parameters to be used is an example. That is, the combination of parameters to be used is not limited to the above combination, and four or more parameters may be set as parameters to be used.

At step S12, the target range setting unit 30 obtains the initial target ranges, and sets them as target ranges to be used (FIG. 10A).

Then, at step S14, the candidate process plan creation unit 32 creates a candidate process plan. The candidate process plan creation unit 32 refers to the job DB 50 and creates a candidate process plan such as illustrated in FIG. 3 by using local search, for example.

Then, at step S16, the parameter value calculation unit 34 calculates each parameter value of the candidate process plan created by the candidate process plan creation unit 32. Here, as an example, it is assumed that the parameter “time variation” is “20%”, the parameter “unit aggregation” is “7”, and the parameter “automation rate” is “40%” as illustrated in “plan1” in FIG. 10B.

Then, at step S18, the parameter value calculation unit 34 stores the parameter values calculated at step S16 in the parameter value storage unit 52.

Then, at step S20, the comparison unit 36 compares the parameter values with the respective target ranges. In the case of “plan1” in FIG. 10B, no parameter value is within the corresponding target range. Thus, “×” is presented. Then, at step S22, the comparison unit 36 determines whether all the parameter values are within the respective target ranges. In the case of “plan1” in FIG. 10B, the determination at step S22 is NO.

When the determination at step S22 is NO, the process returns to step S14. Thereafter, until the determination at step S22 becomes YES, the processes and determination of steps S14 through S22 are repeated.

In the present embodiment, as illustrated in FIG. 10C, candidate process plans (plan2, . . . , planN) are created. It is assumed that all the parameter values fall within the respective target ranges in the candidate process plan “planN” and the determination at step S22 becomes YES. When the determination at step S22 becomes YES, the process moves to step S24.

At step S24, the correlation model creation unit 44 obtains the stored parameter values from the parameter value storage unit 52 (FIG. 7A).

Then, at step S26, the correlation model creation unit 44 calculates correlation models, and stores the created correlation models in the correlation model storage unit 54 (FIG. 7B). In this case, as described previously, based on data indicated by open circles in FIG. 8A through FIG. 8C, the correlation model (a linear expression) of each pair of two parameters is calculated by the least-square method or the like. In the present embodiment, it is assumed that the correlation model of the automation rate (X) and the time variation (Y) is represented by Y=a₁X+b₁, the correlation model of the unit aggregation (X) and the automation rate (Y) is represented by Y=a₂X +b₂, and the correlation model of the unit aggregation (X) and the time variation (Y) is Y=a₃X+b₃.

Then, at step S28, the output unit 38 outputs the candidate process plan that was created when the determination at step S22 became YES to the display unit 93.

The process plan formulator checks the candidate process plan, and inputs the decision of whether to adopt the displayed candidate process plan as a process plan through the input unit 95.

Then, at step S30, the target range acquisition unit 40 determines whether the candidate process plan is adopted. When the determination at step S30 is YES, the entire process in FIG. 9 is ended. On the other hand, when the determination at step S30 is NO, the target range acquisition unit 40 moves to step S32.

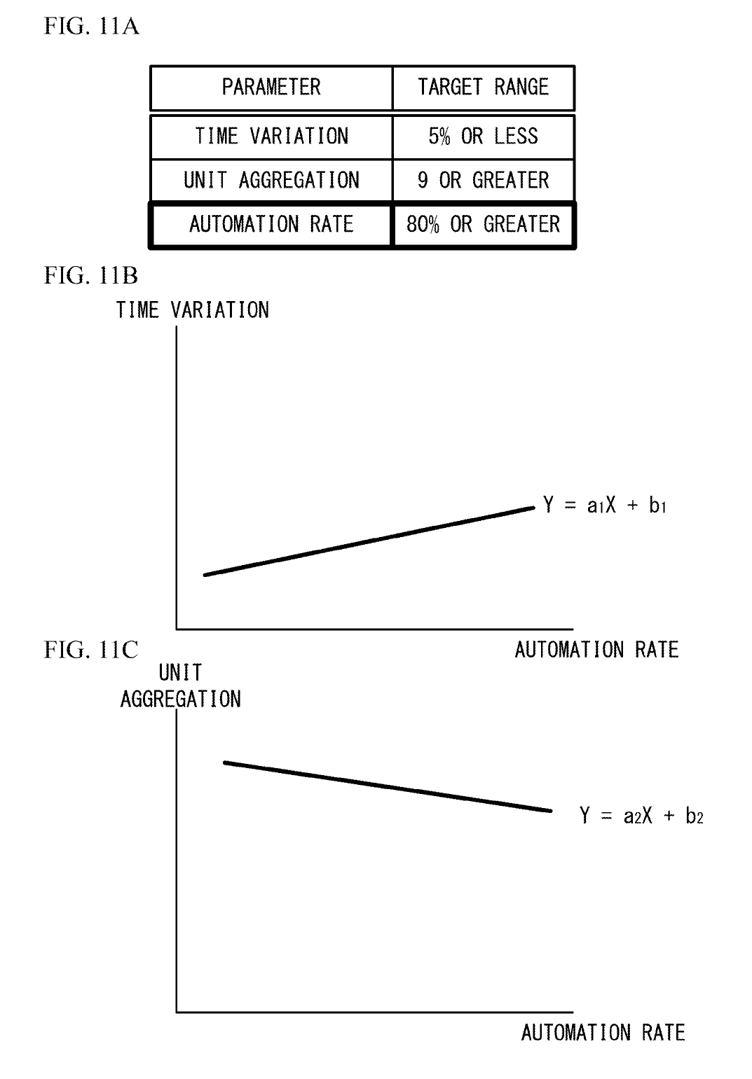

At step S32, the target range acquisition unit 40 waits until at least one of the target ranges is changed. That is, the target range acquisition unit 40 waits until the user specifies one of three parameters and changes the target range for the specified parameter. In the present embodiment, as an example, it is assumed that the process plan formulator who checked the candidate process plan specifies the parameter “automation rate” and changes the target range for the “automation rate” to “80% or greater” because the operation time of the robot is too short in the current candidate process plan (see FIG. 11A).

Then, at step S34, the target range acquisition unit 40 obtains the target range for the parameter changed by the user. Then, at step S36, the target range calculation unit 46 calculates the target range for the parameter other than the parameter of which the target range was changed by the process plan formulator with use of the correlation models.

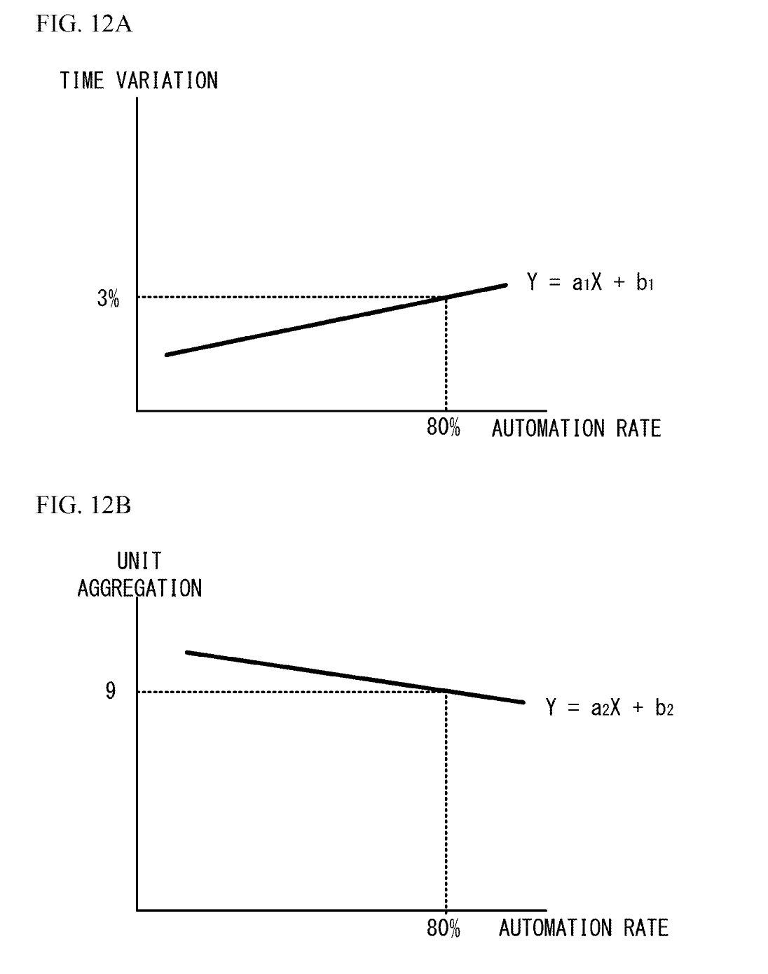

Hereinafter, a detailed description will be given of the process by the target range calculation unit 46.
(1) First, the target range calculation unit 46 reads from the correlation model storage unit 54 the correlation models including the parameter changed by the process plan formulator. In this case, the correlation models illustrated in FIG. 11B and FIG. 11C are read.
(2) Then, the target range calculation unit 46 determines a new target range corresponding to the target range for the parameter changed by the process plan formulator (the “automation rate” is “80% or greater”) for the unchanged target range of the parameter by using the correlation models. For example, it is assumed that the correlation model Y=a₁X+b₁ in FIG. 12A is Y=0.05X−0.01. In this case, the time variation (Y) is Y=0.05×0.8−0.01=0.03. Thus, the target range for the “time variation” corresponding to the target range “80% or greater” for the “automation rate” is determined to be “3% or less”. Additionally, for example, it is assumed that the correlation model Y=a₂X+b₂ in FIG. 12B is Y=−2.5X+10.9. In this case, the unit aggregation (Y) is Y=−2.5×0.8+10.9=8.9. Thus, by rounding off (rounding up) the calculated value to the closest whole number, the target range for the “unit aggregation” corresponding to the target range “80% or greater” for the “automation rate” is determined to be “9 or greater”.

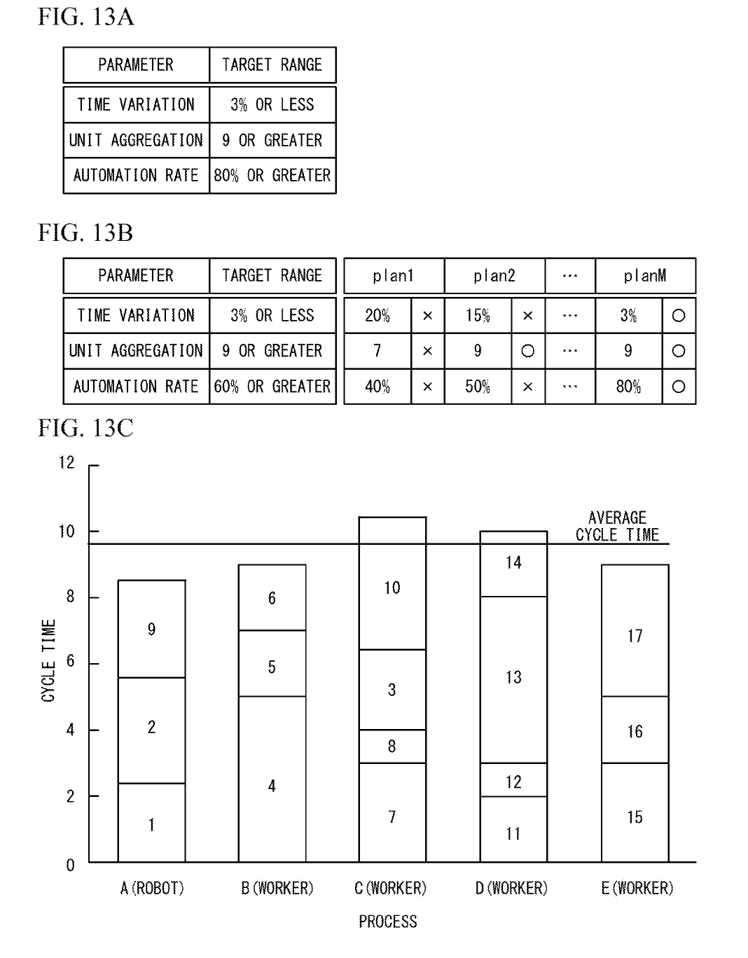

Returning to FIG. 9, at subsequent step S38, the target range setting unit 30 sets new target ranges such as illustrated in FIG. 13A, and returns to step S14. Returning to step S14, the repetitive processes of steps S14 through S22 are executed again. In this case, as illustrated in FIG. 13B, it is assumed that all the parameter values fall within the respective target ranges (S22: YES) when “planM” obtained by repeating steps S14 through S22 M times is created. Then, when the process moves to step S28 through steps S24 and S26, the output unit 38 outputs the candidate process plan “planM”. It is assumed that the candidate process plan “planM” is such as illustrated in FIG. 13C, for example. When the process plan formulator checks the display in FIG. 13C and inputs the adoption of the candidate process plan through the input unit 95, the entire process in FIG. 9 is ended. On the other hand, when the process plan formulator inputs the rejection of the candidate process plan in FIG. 13C through the input unit 95, the processes of steps S32 through S38 are executed and new target ranges are determined.

As described above, the execution of the process in FIG. 9 enables the process plan formulator to set the appropriate target ranges of the remaining parameter values by changing the target range of at least one parameter value. This configuration enables to output an appropriate candidate process plan in short time.

As seen from the above description, in the present embodiment, a first repetition unit and a second repetition unit, which repeat the creation of a candidate process plan and the calculation of parameter values until all the parameters fall within the respective target ranges, include the candidate process plan creation unit 32, the parameter value calculation unit 34, and the comparison unit 36. In addition, in the present embodiment, a determination unit, which determines the target range of the parameter value not changed by the process plan formulator, includes the correlation model creation unit 44 and the target range calculation unit 46.

As described in detail above, in the present embodiment, the process planning device 10 repeats a process of creating a candidate process plan by assigning a plurality of j obs to a plurality of processes (S14) and calculating a plurality of parameter values of the created candidate process plan (S16) until all of a plurality of calculated parameter values fall within the respective target ranges (S22), and stores the calculated parameter values in the parameter value storage unit 52 (S18). Additionally, the process planning device 10 outputs the candidate process plan in which all the parameter values are within the respective target ranges (S28), and when the process plan formulator changes the target range for one parameter, calculates the target value for the parameter not changed by the process plan formulator based on the changed target range of the one parameter and the parameter values stored in the parameter value storage unit 52 (S34, S36). Then, the process planning device 10 repeats the process of creating the candidate process plan (S14) and calculating a plurality of parameter values of the created candidate process plan (S16) until all the calculated parameter values fall within the respective new target ranges (S22), and outputs the candidate process plan in which all the parameter values are within the respective new target ranges (S28). This configuration allows, when the process plan formulator checks the output candidate process plan and is not satisfied with the output candidate process plan, the target ranges of the remaining parameter values to be automatically changed to appropriate ranges by referring to the candidate process plan and changing the target value of one parameter value. Thus, even when the process plan formulator changes the target range of the parameter value, problems caused by the change, for example, the candidate process plan that can be output is not found or it takes a lot of time to find the candidate process plan, are avoided. In this case, the process plan formulator does not need to repeat trial and error to find out the target ranges of the remaining parameter values corresponding to the changed target range of one parameter value, and thus can set an appropriate parameter value in short time. In addition, in the present embodiment, an appropriate candidate process plan can be output in short time. Thus, the time required to determine a process plan is reduced.

In addition, in the present embodiment, when calculating the target range of the parameter value not changed by the process plan formulator, the correlation model creation unit 44 calculates models (linear expressions) representing correlations between parameters stored in the parameter value storage unit 52. The target range calculation unit 46 calculates the unchanged target range of the parameter value based on the calculated models (linear expressions) and the target range of the parameter value changed by the process plan formulator. This configuration enables to calculate the unchanged target range of the parameter value based on the relationships between parameter values in the past and the target range of the parameter value changed by the process plan formulator so that the probability of presence of the candidate process plan that can be output increases.

In addition, in the present embodiment, each process in the assembly line 20 includes a process in which a robot executes jobs and a process in which a worker executes jobs. In the assembly line where a robot and a worker are mixedly assigned, the number of parameters to be taken into consideration is very large. However, by using the method of the present embodiment, the target value of the parameter value can be easily and appropriately set. The present embodiment does not intend to suggest any limitation, and the assembly line 20 may not necessarily include a process in which a robot executes jobs. Alternatively, the assembly line 20 may not necessarily include a process in which a worker executes jobs.

The above embodiment describes a case where the process plan formulator sets initial target ranges, but does not intend to suggest any limitation. For example, in the process planning device 10, initial target ranges may be automatically set. Even in this case, the process planning device 10 preferably sets a low (bad) target range as the target range of each parameter value.

The above embodiment describes a case where the process plan formulator changes the target range of one parameter value, but does not intend to suggest any limitation. For example, the process plan formulator may change target ranges for two or more parameters of the parameters. In this case, the unchanged target range of one parameter is calculated based on each of the changed target ranges, and the average of the calculated target ranges may be determined as the unchanged target range of one parameter. In addition, when the target ranges for two or more parameters are changed, the process planning device 10 may determine whether the changed target range is appropriate based on the correlation models and output the determination result.

The above-described processing functions are implemented by a computer. In this case, a program in which processing details of the functions that a processing device (CPU) is to have are written are provided. The execution of the program by the computer allows the computer to implement the above described processing functions. The program in which the processing details are written can be stored in a storage medium (however, excluding carrier waves) capable of being read by a computer.

When the program is distributed, it may be sold in the form of a portable storage medium such as a DVD (Digital Versatile Disc) or a CD-ROM (Compact Disc Read Only Memory) storing the program. The program may be stored in a storage device of a server computer, and the program may be transferred from the server computer to another computer over a network.

A computer executing the program stores the program stored in a portable storage medium or transferred from a server computer in its own storage device. The computer then reads the program from its own storage device, and executes a process according to the program. The computer may directly read the program from a portable storage medium, and execute a process according to the program. Alternatively, the computer may successively execute a process, every time the program is transferred from a server computer, according to the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer readable storage medium storing a process planning program that causes a computer to execute a process, the process comprising:
repeating a process of creating a candidate process plan, by assigning a plurality of jobs to a plurality of processes, and calculating a plurality of parameter values of the candidate process plan until a plurality of calculated parameter values fall within respective first target ranges of the plurality of parameter values;
storing the plurality of calculated parameter values in a storage unit;
outputting the candidate process plan in which all of the plurality of calculated parameter values are within the respective first target ranges;
when receiving input of information about a parameter value specified from among the plurality of parameter values by a user and information about a change of a target range of a specified parameter value to a second target range, determining a third target range of a parameter value not specified by the user based on the second target range and a plurality of parameter values stored in the storage unit;
repeating the process of creating a candidate process plan and calculating the plurality of parameter values of the candidate process plan until the parameter value specified by the user of the plurality of calculated parameter values falls within the second target range and the parameter value not specified by the user falls within the third target range; and
outputting a candidate process plan in which all of the plurality of parameter values are within respective target ranges.

2. The non-transitory computer readable storage medium according to claim 1, wherein
the determining of the third target range includes creating a model representing a correlation between parameter values stored in the storage unit, and determining a range of the parameter value not specified by the user corresponding to the second target range of the parameter value specified by the user based on the model representing the correlation as the third target range.

3. The non-transitory computer readable storage medium according to claim 1, wherein
the plurality of processes include a process executed by a robot and a process executed by a human.

4. The non-transitory computer readable storage medium according to claim 1, wherein the first target range is a range specified by a user.

5. A process planning method implemented by a computer, the process planning method comprising:
repeating a process of creating a candidate process plan, by assigning a plurality of jobs to a plurality of processes, and calculating a plurality of parameter values of the candidate process plan until a plurality of calculated parameter values fall within respective first target ranges of the plurality of parameter values;
storing the plurality of calculated parameter values in a storage unit;
outputting the candidate process plan in which all of the plurality of calculated parameter values are within the respective first target ranges;
when receiving input of information about a parameter value specified from among the plurality of parameter values by a user and information about a change of a target range of a specified parameter value to a second target range, determining a third target range of a parameter value not specified by the user based on the second target range and a plurality of parameter values stored in the storage unit;
repeating the process of creating a candidate process plan and calculating the plurality of parameter values of the candidate process plan until the parameter value specified by the user of the plurality of calculated parameter values falls within the second target range and the parameter value not specified by the user falls within the third target range; and
outputting a candidate process plan in which all of the plurality of parameter values are within respective target ranges.

6. A process planning device comprising:
a memory; and
a processor coupled to the memory and configured to:
repeat a process of creating a candidate process plan, by assigning a plurality of jobs to a plurality of processes, and calculating a plurality of parameter values of the candidate process plan until a plurality of calculated parameter values fall within respective first target ranges of the plurality of parameter values;
store the plurality of calculated parameter values in a storage unit;
output the candidate process plan in which all of the plurality of calculated parameter values are within the respective first target ranges;
receive input of information about a parameter value specified from among the plurality of parameter values by a user and information about a change of a target range of a specified parameter value to a second target range;
determine a third target range of a parameter value not specified by the user based on the second target range and a plurality of parameter values stored in the storage unit;
repeat the process of creating a candidate process plan and calculating the plurality of parameter values of the candidate process plan until the parameter value specified by the user of the plurality of calculated parameter values falls within the second target range and the parameter value not specified by the user falls within the third target range; and
output a candidate process plan in which all of the plurality of parameter values are within respective target ranges.
